(19) United States
(12) Patent Application Publication
(10) Pub. No.: US 2004/0153300 A1
(43) Pub. Date: Aug. 5, 2004

(54) Signature simulator

(76) Inventors: Peter F. Symosek, Shoreview, MN (US); Darryl G. Busch, Eden Prairie, MN (US); Kwing W. Au, Bloomington, MN (US); James W. Kauffman, Dunedin, FL (US); Michael J. Flanagan, St. Petersburg, FL (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/718,168

(22) Filed: Nov. 20, 2003

Related U.S. Application Data
(60) Provisional application No. 60/428,205, filed on Nov. 20, 2002.

(51) Int. Cl. G06G 7/48; G06G 7/58

(52) U.S. Cl. 703/11

(57) ABSTRACT

A simulator which may provide interferometer-based signatures of agent, stimulant, interferent and toxic chemicals for scenarios to test sensors, detectors and like systems. The simulator may assimilate data and information related to a calibrated background spectrum, and atmospheric and cloud models for simulating signatures and corresponding scenarios. Data and information may include, but not limited to, field data, atmospheric conditions, agent absorption coefficients, system performance requirements. Various modeling and computing tools may be incorporated in the simulation process.

### BACKGROUND

This application claims priority under 35 U.S.C. § 119(e)(1) to co-pending U.S. Provisional Patent Application No. 60/428,205, filed Nov. 20, 2002, and entitled “Methodology to Synthesize Agent, Simulant, Interferent or Toxic Industrial Chemical Signatures for an Interferometer-Based Spectral Sensor”, wherein such document is incorporated herein by reference.

The U.S. Government may have certain rights in the present invention.

The present invention relates to simulation and particularly to simulation of scenarios for testing detectors and related systems. More particularly, it relates to scenarios that include simulated interferometer-based signatures of agent, stimulant, interferent and toxic chemicals.

Testing of detectors or systems in real situations and scenarios involving field measurements may often be very expensive and quite hazardous. In lieu of the field measurements, traditional simulations have been used. However, they have been often inadequate for testing detectors, sensors and related systems. Typically, traditional simulations have been predicated on the principles of physics and do not necessarily represent accurately the phenomenological behavior needed for the testing the detectors, sensors, systems, and the like.

### SUMMARY

The present invention is an approach for constructing, calculating and/or synthesizing agent, simulant, interferent, toxic or non-toxic chemical signatures to provide possible scenarios for testing an interferometer-based spectral sensor, detector, system, or the like. The simulations may address the artifacts and parameters specific to a distinct sensor, detector or system. The present signature synthesis methodology may be different from that in the related art because of its relatively precise representation of sensor artifacts, sensor sampling error and sensor signal-to-noise ratio.

### BRIF DESCRIPTION OF THE DRAWING

FIG. 1 shows a block diagram of an algorithm design methodology;

FIG. 2 shows the geometry of the two-slab cloud model for the agent/simulant/interferent simulation;

FIG. 3 is a block diagram of a baseline simulation;

FIG. 4 reveals the computational stages of the baseline simulation;

FIG. 5 is a top-level diagram of a detector chemical agent simulation;

FIG. 6 is a diagram of the preparation stage for the simulation;

FIG. 7 is a diagram of the calibration stage of the simulation;

FIG. 8 is a diagram of the restoration stage of the simulation;

FIG. 9 is a diagram of the major components of the simulation software;

FIG. 10 shows a profile of the values from a start scan to an end scan in a simulation run;

FIG. 11 high level operational flow diagram of the simulation software; and

FIG. 12 shows the removal of the original apodization effect by dividing the truncated interferogram with a window.

### DESCRIPTION

The invention may be an interferometer-based chemical agent simulator which may synthesize agent, simulant, interferent and/or toxic or non-toxic chemical signatures in background interferograms. The signatures may be collected by an arbitrary interferometer sensor. Further, there may be simulated sensor outputs that have similar characteristics of a distinct, possibly non-existent sensor. The simulator may produce simulations to be integrated into an automated experiment configuration and/or performance evaluation environment to test sensors, detectors, and related systems. One detector, sensor or system that may be tested is a Joint Services lightweight stand-off chemical agent detector (JSLSCAD). The JSLSCAD may be regarded as a state-of-the-art interferometer-based chemical agent detector having baseline chemical agent detection algorithms. Although the present simulator may be used for testing many kinds of sensors, detectors and systems, the JSLSCAD may be considered as an example detector that may be provided simulated chemical agent signatures.

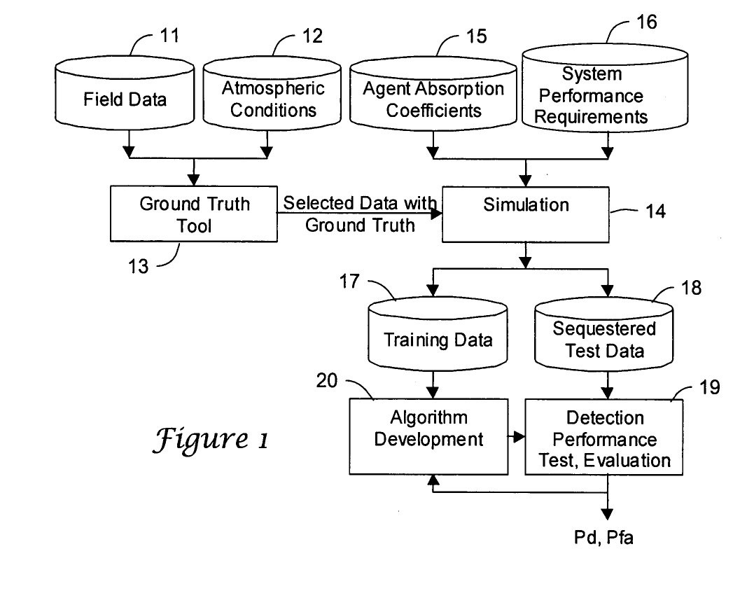

The simulator may be designed with algorithms to calculate and/or synthesize artificial interferometer-based signatures for a simulation of a scenario to be sensed. FIG. 1 shows a block diagram of an algorithm design methodology. Field data 11 and atmospheric conditions 12 may be input into a ground truth tool 13. Ground truth tool 13 may allow the user to enter or establish the ground truth, e.g., types of background, and tool 13 may compute some basic features of the input, e.g., peak amplitude, locations and kurtosis. (Kurtosis may be a quantity indicative of a general form of a statistical frequency curve near the mean of a distribution.) Selected data with ground truth from tool 13 may go to a simulation block 14. Also input to simulation block 14 may be agent absorption coefficients 15 and system performance requirements 16. Simulation 14 may add chemical agent and/or common battle field signatures to background data which cannot be obtained in field collection. Simulation 14 may have training data 17 output and a sequestered test data 18 output. Sequestered test data 18 may be input to detection performance test and evaluation 19. Training data 17 may be input to algorithm 20. An output of algorithm 20 may go to detection performance test and evaluation 19. Pd (probability of detection) and Pfa (probability of false alarms) signals may be an output of Detection performance test and evaluation 19. This output may be fed to algorithm development 20. Detection performance test and evaluation 19 may test the sensor or detector outputs (both field and simulated data) with a suite of algorithms. It may also evaluate the performances via a comparison with ground truth information 13. Algorithm development 20 may design, code and train detection algorithm candidates based on the sensor, agent/interferents and background phenomenologies. Features of the algorithm design methodology may include model based on first principle phenomenology and a unified simulation, development/train, test and performance evaluation package.

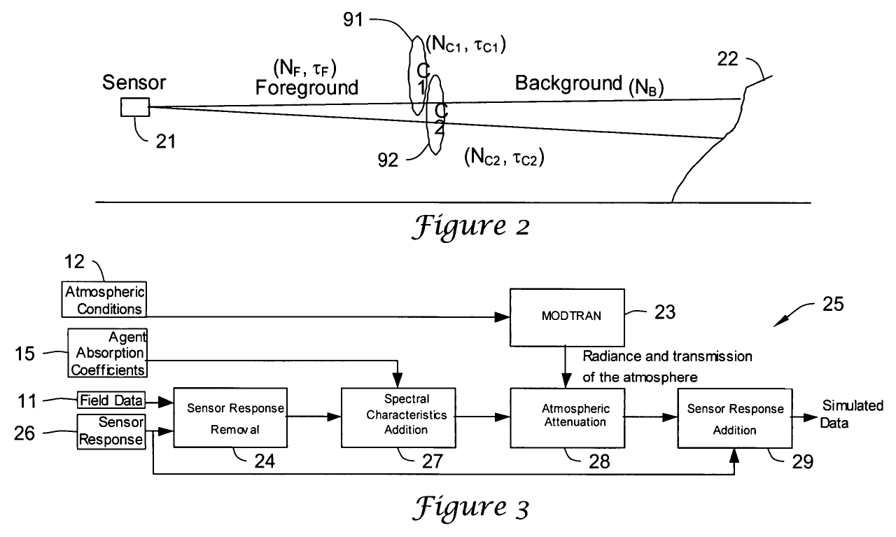

A baseline detector or sensor chemical agent simulation 25 may be designed for calculation of synthetic chemical agent signatures utilizing background scene measurements obtained with an arbitrary sensor 21 of FIG. 2. A measurement may be transformed into a synthetic representation of the sensor data that would be obtained with a possibly distinct sensor, utilizing chemical agent absorptivity coefficients, specifications for the sensor's sample comb, the scene configuration and the signal-to-noise ratio of sensor 21. The baseline simulation configuration for signature synthesis is shown in FIG. 2 with radiance (N_{C1}) and transmission (τ_{C1}) of the front cloud slab C1, radiance (N_{C2}) and transmission (τ_{C2}) of the back cloud slab C2, the background of the scene with radiance (N_{B}) and foreground (N_{F}, τ_{F}).

A block diagram of simulation 25 is shown in FIG. 3. The major components of simulation 25 may include sensor response removal 24, spectral characteristics addition 27, atmospheric attenuation 28, MODerate-resolution atmospheric TRANmittance and radiance model (MODTRAN) 23, and sensor response addition 29. MODTRAN is a FORTRAN-like computer code designed to determine or model atmospheric transmission and radiance. MODTRAN was developed principally by the U.S. Air Force Research Laboratories. Simulation 25 may include sensor response removal having inputs from field data 11 and sensor response 26, and an output connected to an input of a spectral characteristics addition 27.Agent absorption coefficients 15 may be connected to another input of special characteristics addition 27. An output of special characteristics addition 27 may be connected to an input of atmospheric attenuation 28. MODTRAN 23 may have an input from atmospheric conditions 12 and an output pertaining to radiance and transmission of the atmosphere connected to another input of atmospheric attenuation 28. An output from atmospheric attenuation may be connected to an input of sensor response addition 29. Sensor response 26 may be connected to another input of sensor response addition 29. An output of sensor response addition 29 may be simulated data.

Sensor response removal 24 may remove the sensor induced affects in the input signal and the output is sensor-independent signature of the background. Spectral characteristic addition 27 may have the signatures of the agent and/or battlefield interferents added to the background only signature. The signatures may be based on the concentration, temperature difference, and field of view (FOV) coverage. Atmospheric attenuation 28 may have the signature properly adjusted due to the atmospheric transmission, based on the range of the agent cloud and atmospheric conditions. Sensor response addition may have the affects of the sensor response introduced into the signature, creating the simulated data that the sensor should output.

Features of simulation 25 may include a first principle phenomenological model (spectral absorption/radiation) and Government off the shelf (GOTS) proven atmospheric models may be used relative to MODTRAN 23. Simulation 25 may be sensor independent (i.e., may simulate signature of arbitrary Fourier transform infrared (FTIR) spectrometers, including JSLSCAD) Simulation 25 may have two agent/interferent clouds that allow multiple agents and battlefield entries, which can be either mixed or separated.

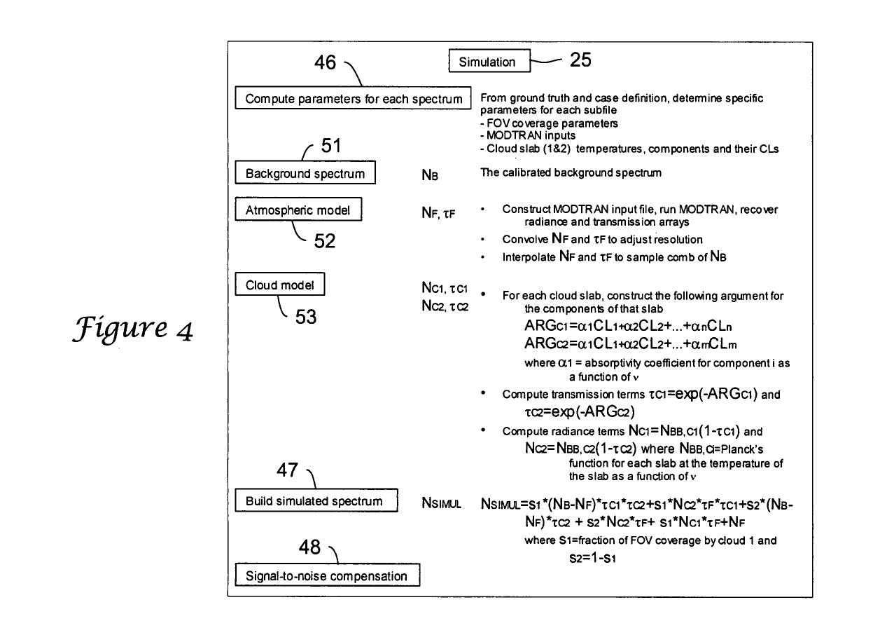

The computational stages of the baseline simulation 25 for the detector are shown in FIG. 4. Parameters for each spectrum 46 may be computed. From ground truth of tool 13 and from case definition, specific parameters may be determined for each subfile. These parameters may include FOV coverage parameters, MODTRAN 23 inputs, cloud slab (C1 and C2) temperatures, components and their CLs. A calibrated background spectrum 51 (N_{B}) may be obtained. Relative to an atmospheric model 52 from conditions 12, a MODTRAN 23 input file may be constructed. MODTRAN 23 may be run and the radiance N_{F} and transmission τ_{F} arrays may be recovered. N_{F} and τ_{F} may be convolved with a sinc function representing the Fourier transform of the temporal averaging window corresponding to the sample spacing of the interferometer to adjust resolution. Also, N_{F} and τ_{F} may be interpolated to sample a comb of N_{B}.

A cloud model 53 involving N_{C1}, τ_{C1} and N_{C2} and τ_{C2} may be determined. For each cloud slab (C1 and C2), an argument (ARG) may be constructed for the components of the respective slab.

ARG_{C1}=α₁CL₁+α₂CL₂+ . . . +αₙCLₙ

ARG_{C2}=α₁CL₁+α₂CL₂+ . . . +αₘCLₘ

where αᵢ=absorptivity coefficient for component i as a function of ν. Transmission terms τ_{C1}=exp(−ARG_{C1}) and τ_{C2}=exp (−ARG_{C2}) may be computed. Also computed may be radiance terms N_{C1}=N_{BB,C1} (1−τ_{C1}) and N_{C2}=N_{BB,C2} (1−τ_{C2}) where N_{BB,C}=Planck's function for each slab at the temperature of the slab as a function of ν.

A simulated spectrum 47 (N_{SIMUL}) may be built as indicated by the following equation.

N_{SIMUL}=S₁*(N_{B}−N_{F})*τ_{C1}*τ_{C2}+S₁*N_{C2}*τ_{F}*τ_{C1}+S₂*(N_{B}−N_{F})*τ_{C2}+S₂*N_{C2}*τ_{F}+S₁*N_{C1}*τ_{F}+N_{F},

where S₁=fraction of FOV coverage by cloud 1 and S₂=1−S₁. Then a signal-to-noise compensation 48 may be incorporated.

An alternate realization of the phenomenological synthesis calculation may be the following. If the sensor-based measurement is defined to be the background of the scene, then a methodology may exist to estimate the signature that would be observed if the sensor was actually further away from the scene along the same view direction. The reference scene does not have to be compensated for the atmosphere between the sensor and the agent cloud because the agent cloud may be envisioned to be located at the sensor location. The “virtual” sensor may be further away from the scene along the view direction of the sensor for the original sensor data. Then the equation designated “Build simulated spectrum” in FIG. 4 may become

N_{SIMUL}=s₁*N_{B}*τ_{C1}*τ_{C2}*τ_{F}+s₁*N_{C2}*τ_{F}*τ_{C1}+s₂*N_{B}*τ_{C2}*τ_{F}+s₂*N_{C2}*τ_{F}+s₁*N_{C1}*τ_{F}+N_{F},

where

s₁=fraction of FOV coverage by cloud 1 and

s₂=1−s₁

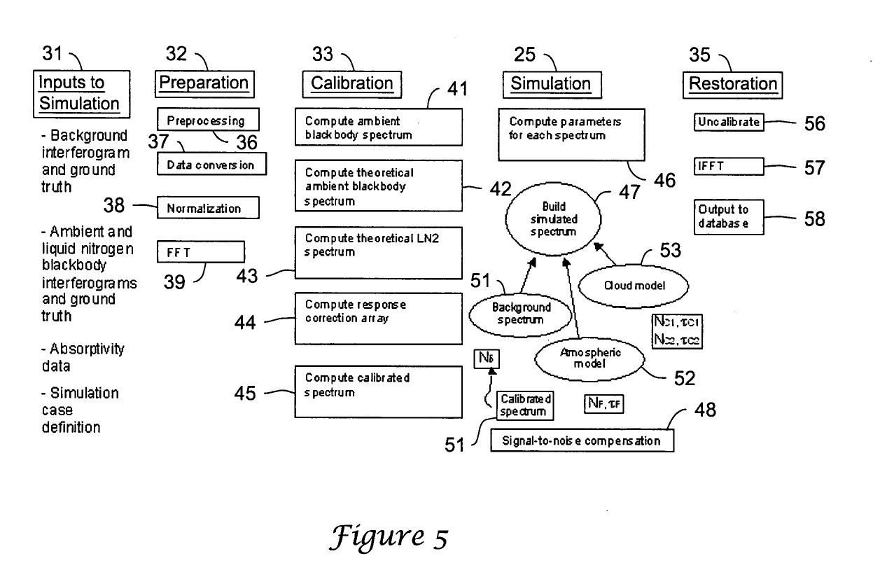

FIG. 5 is a top-level diagram of the detector (e.g., JSLSCAD) chemical agent simulation. It shows inputs 31 (to simulation 25), preparation 32, calibration 33, simulation 25 and restoration 35. Inputs 31 to simulation 25 may include a background interferogram and ground truth, ambient and liquid nitrogen blackbody interferograms and ground truth, absorptivity data and a case definition of the simulation. Preparation 32 may include preprocessing 36, data conversion 37, normalization 38 and fast Fourier transform (FFT) 39. Calibration 33 may include compute ambient blackbody spectrum 41, compute theoretical ambient blackbody spectrum 42, compute theoretical LN₂ spectrum 43, compute response correction array 44 and compute calibrated spectrum 45. Simulation 25 may include compute parameters for each spectrum 46, build simulated spectrum 47 and signal-to-noise compensation 48. Build simulated spectrum 47 may have inputs background spectrum 51 (calibrated N_{B}), atmospheric model 52 (N_{F}, T_{F}), and cloud model 53 (N_{C1}, τ_{C1}, N_{C2}, τ_{C2}). Restoration 35 may include uncalibrate 56, inverse fast Fourier transform (IFFT) 57 and output to database 58. FIG. 4 is a simulation stage 25 block diagram.

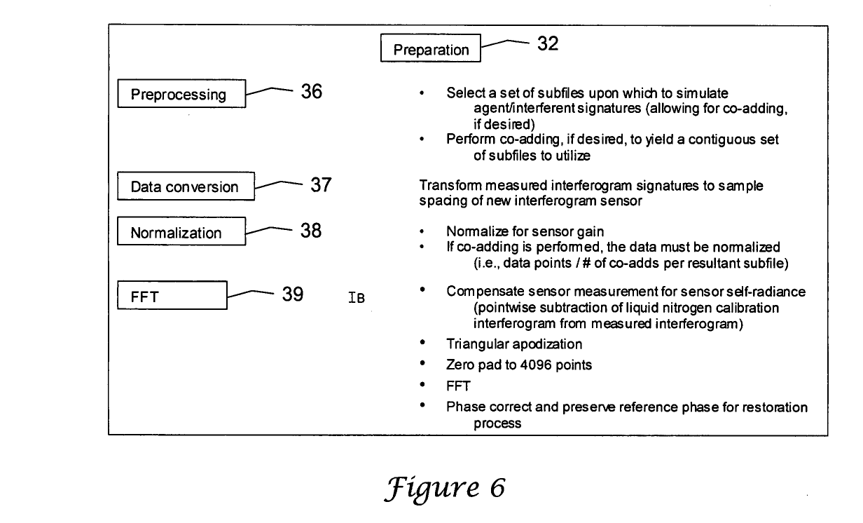

FIG. 6 is a preparation stage 32 block diagram. Preprocessing 36 may select a set of subfiles upon which to simulate agent/interferent signatures (allowing for co-adding, if desired) and perform co-adding, if desired, to yield a contiguous set of subfiles to utilize. Data conversion 37 may transform measured interferogram signatures to sample spacing of a new interferogram sensor. Normalization 38 may normalize for sensor gain and, if co-adding is performed, the data should be normalized (i.e., data points/# of co-adds per resultant subfile). FFT 39 (I_{B}) may compensate sensor measurement for sensor self radiance (pointwise subtraction of a liquid nitrogen calibration interferogram from a measured interferogram), triangular apodization (i.e. a tapering function), zero pad to 4096, FFT and phase correct and preserve reference phase for restoration process.

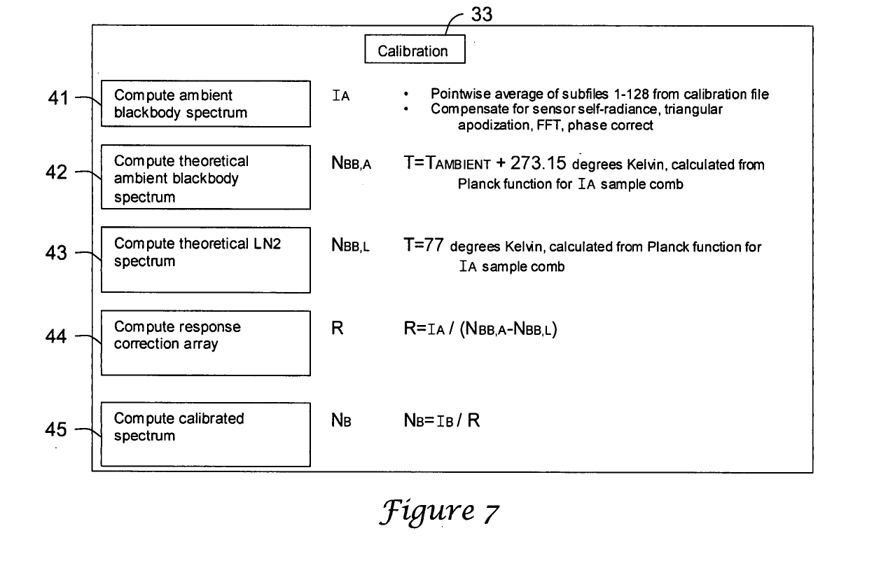

FIG. 7 is a calibration stage 33 block diagram. Compute ambient blackbody spectrum 41 (I_{A}) may include a pointwise average of subfiles 1-128 from calibration file and a compensation for sensor self radiance, triangular apodization, FFT and phase correct. Compute theoretical ambient blackbody spectrum 42 (N_{BB,A}) may be at T=T_{AMBIENT}+273.15 degrees Kelvin, calculated from a Planck function for an I_{A} sample comb. Compute theoretical LN₂ spectrum 43 (N_{BB,L}) may be at T=77 degrees Kelvin, calculated from a Planck function for an I_{A} sample comb. Compute response correction array 44 (R) where R may be calculated as I_{A}/(N_{BB,A}−N_{BB,L}). Compute calibrated spectrum 45 (N_{B}) where N_{B} may be calculated as I_{B}/R.

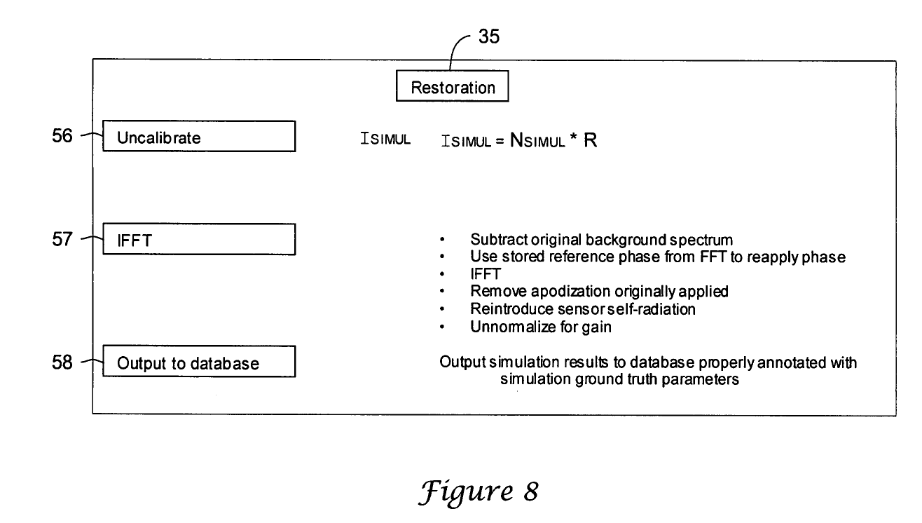

FIG. 8 is a restoration stage 35 block diagram. Uncalibrate 56 (I_{SIMUL}) where I_{SIMUL} may be calculated as N_{SIMUL}*R. IFFT 57 may subtract the original background spectrum, use a stored reference phase from FFT to reapply phase, IFFT, remove the apodization originally applied, reintroduce sensor self-radiation and unnormalize for gain. Output to database 58 may output simulation results to a database properly annotated with simulation ground truth parameters.

There may be simulation software that adds the chemical agents and/or common battlefield inferents into background interferograms. Simulation software may synthesize agent, simulant and/or inferent signatures in background interferograms which may be collected by a sensor. The outputs may be sensor specific and expected to have similar characteristics of the anticipated sensor. The simulation may address many artifacts and parameters specific to the sensor. A simulation that may apply to a different sensor would require modification to the simulation software. The terms “scan” and “interferogram” may be used interchangeably. A scan or interferogram may mean a 2048 point data sequence that is or simulates the sensor output. Each data point of the sequence may be represented by a 16 bit word.

The assumptions and requirements needed to complete the simulation software may include a local, executable MODTRAN (version 3.7) which can be invoked by the simulation software, an executable MATLAB® (version 5.2) and its signal processing toolbox which can be invoked by the simulation software. MATLAB® (Matlab) may be used as a numerical computing tool. The background interferograms used for simulation may be already imported in chemical agent detection software environment (CADSE) database. Also, these interferograms may be already converted to have the same attributes as the JSLSCAD, e.g., 4 wavenumber resolution and 2048 points. The ancillary information associated with the interferograms (e.g., ambient blackbody and liquid nitrogen references) may be also correctly stored in the CADSE database. The absorption coefficients of the agent and interferents may be stored in a file whose format, resolution, and number of points are specified.

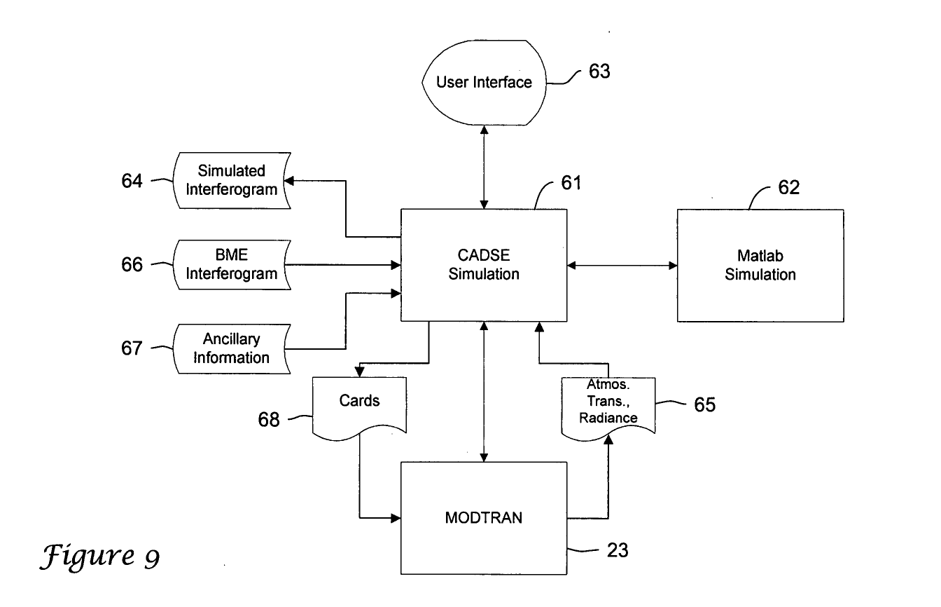

The simulation software may be partitioned into three major components: CADSE simulation 61, Matlab simulation 62 and MODTRAN 23. A user interface 63 may be part of CADSE simulation 61. FIG. 9 shows the connections between the components. User interface 63 may have a two-way connection with CADSE simulation 61. CADSE simulation 61 may have input connections from atmospheric transmittance and radiance 65, background measurement experiment or environment (BME) interferogram 66 and ancillary information 67. CADSE simulation 61 may also have two-connections with MODTRAN 23 and Matlab simulation 62. CADSE simulation 61 may have output connections to simulated interferogram 64 and cards 68. MODTRAN 23 may have an input connection from cards 68 and an output connection to atmospheric transmittance and radiance 65. Atmospheric transmittance and radiance 65 may be the atmospheric information from MODTRAN 23 to CADSE simulation 61.

CADSE simulation 61 may be the coordinator that obtains the necessary information from the user via user interface 63, gets BME background interferogram 66 and associated or ancillary information 67 from the CADSE database, creates the protocols to MODTRAN 23 and Matlab 62, and saves simulated interferograms 64 and their ground truth information into the CADSE database. MODTRAN 23 may be the software for standard atmospheric transmission and radiance 65 model. MODTRAN 23 may be used to produce foreground atmospheric transmission and radiance.

Matlab simulation 62 may generate the simulated interferograms 64 based on a two-slab cloud model. All of the mathematical computations may be performed in Matlab simulation module 62. However, the simulation software may run using Matlab or C. The simulation software may require numerous inputs, which can be grouped into three categories: MODTRAN 23 related, background interferogram related, and cloud slab related. All the input values for a simulation run may be saved and recalled for future reference.

The following items pertain to MODTRAN 23 related parameters. Sets of eight cards 68 (i.e. input files in card format) may be utilized for providing required inputs to the MODTRAN 23 model. The values of most parameters may be fixed for this application. Values of some parameters may vary depending on the scenario, which the user may input via interface 63. Alternative values may indicate options that are related to different background and simulation scenarios. CADSE simulation 61 may develop the sets of cards 68 based on the user inputs and the above-noted fixed parameter values. These sets of cards 68 may be saved as a file that is input to the MODTRAN 23 executable.

The background interferogram related parameters may be a category of inputs that relate to the background interferograms 66 in which agent and/or interferent signatures are to be added. Some inputs may specify the background interferograms 66, and some inputs may relate to the background interferograms 66, such as the calibration references. The majority of these inputs may be retrieved from the CADSE database once they are specified. The list of inputs, their format and descriptions are tabulated in Table 1.

TABLE 1
Input parameters related to the input interferograms 66

| | | Value/ | |
|---|---|---|---|
| Name | Format | source | Description |
| Scan set | CADSE | | The scan set specifies the set of interferograms in |
| | UI | | which agent/interferents will be simulated upon. |
| Ambient | | Calibration | Each file that a selected scan originated from is |
| Blackbody | | file | associated with a calibration file. The calibration file |
| Reference | | referred | consists of three sets of references: an ambient |
| | | in global | blackbody set, a polystyrene reference, and a LN₂ |
| | | file | reference set. The ambient blackbody set that |
| | | header | corresponds to the selected scan is needed. |
| LN₂ Reference | | Ditto | This is the LN₂ reference set as stated above |
| Slant angle | | Subfile | The slant angle of the scan. Noted that the angle |
| | | header | required for MODTRAN is Zenith angle, not the |
| | | | elevation angle as in the subfile header. |
| Gain | | Global | The gain of the sensor. |
| | | header | |
| Ambient | | Global | The ambient temperature when the scan was collected. |
| temperature | | header | |
| Barometric | | Global | The barometric pressure when the scan was collected. |
| Pressure | | header | |
| Relative | | Global | The percentage of relative humidity when the scan was |
| humidity | | header | collected. |
| numCoadd | | User | Number of interferograms coadded |

A byproduct of the input information may be the number of scans (subfiles) which the agent and interferents will be simulated upon. This number may be referred as numScan throughout this document.

The following pertains to cloud slab related parameters. Two cloud slabs may be simulated in the model. Further, the model may allow multiple components in each cloud slab. Here, the maximum number of components may be four, even though the number may other than four. The model also may assume that the back slab has 100 percent FOV coverage, and that the front slab may have 0 to 100 percent FOV coverage. To describe the clouds of agent/interferents, following inputs listed in Table 2 may be considered to be required.

TABLE 2
Input parameters related to the cloud slab

| Name | Description |
|---|---|
| Range | Distance profile from the clouds to the sensor (km). |
| | The two clouds are assumed to have the same |
| | distance. |
| Coverage | The field of view coverage profile of the front cloud |
| | slab (C1) in the form of a fraction from 0 to 1. |
| T_{c1} | The temperature profile of the front cloud, C1 |
| NumCompC1 | Number of components in the front cloud |
| CompID_{1,c1} | The ID tag for the first component in C1 |
| CL_{comp1,c1} | The CL profile for the first component in C1 |
| . . . | The ID tag and CL profile for the i^{th} component in |
| | C1 |
| CompID_{numComp1,c1} | The ID tag for the last component in C1 |
| CL_{numComp1,c1} | The CL profile for the last component in C1 |
| T_{c2} | The temperature profile of the back cloud, C2 |
| NumCompC2 | Number of components in the back cloud |
| CompID_{1,c2} | The ID tag for the first component in C2 |
| CL_{comp1,c2} | The CL profile for the first component in C2 |
| . . . | The ID tag and CL profile for the i^{th} component in |
| | C2 |
| CompID_{numComp1,c2} | The ID tag for the last component in C2 |
| CL_{numComp1,c2} | The CL profile for the last component in C2 |

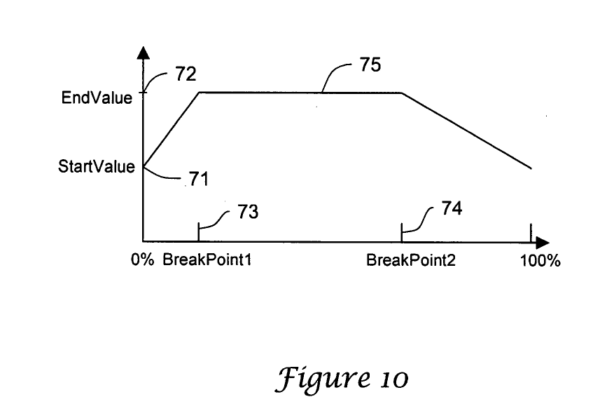

The profile as stated in Table 2 may denote the values from the starting scan to the ending scan in the simulation run (experiment). The profile, which is shown in FIG. 10, may be captured with 4 numbers: startvalue 71, endvalue 72, breakpoint1 73, and breakpoint2 74. StartValue 71 does not need to be smaller than endvalue 72, and the breakpoint1 73 may be less than or equal to breakpoint2 74. Breakpoints1 73 and breakpoint2 74 may be expressed in percentage. Numerous forms of profiles, such as constant, linearly increasing, linearly decreasing and so forth may be specified with these four parameters. FIG. 10 shows a profile 75 that may specify the values from the start scan to ending scan.

Another input related to the cloud slabs is the absorption coefficients file 15, which may store the absorption coefficients of all the agents, simulants and interferents. The format of absorption coeff icient file 15 may be defined as having an open-ended data file, fixed-length records; one agent per record, and vice versa; and an agent “name” in user interface 63 linked to stored index/key.

A given record may contain four elements: Cstring—AgentName; DWORD—IndexKey; CString—Comment; and float—AgentCoefficient [2184]. AgentName may be a unique, recognizable identifier, 2->16 characters in length. IndexKey (also unique) may be transparent to the user, and assigned at the start of the respective record. Comment may be optional, variable (or limited) length. AgentCoefficient array may consist of 2184 floating point values. Upon retrieval, these may be converted to mg/m2 by multiplying stored value * 0.0001. A starting wavenumber (each 1st data point) may be 388.17558 cm⁻¹ and a step may be 0.96716738 cm⁻¹. For reference, the ending wavenumber thus may calculate out to something like 2499.50197 cm⁻¹.

As to outputs of the simulation software, most of them may be stored back into the CADSE database. These outputs may include simulated interferograms 64 as scan representations in the CADSE database. These scans may be associated with a new global file header and subfile information. Another output may be a new global file header. Since the contents of the scans (subfiles) may change, it could be beneficial to have a new global file header associated with the simulated data. In particular, the following information in the global file header may be changed. A filename may change from D******* to S*******, where D stands for data and S stands for simulation. The rest of the character sequence in the file name may be the same. One may note also that the same interferogram could be used multiple times to simulate different agents/simulants/interferents, yielding many interferograms. Thus, the association of the synthesized data with a global header may take into account this situation. Another output may be subfile information originally associated with simulated interferograms 64. An output may also be simulation ground truth information associated with each of the simulated interferograms 64, i.e., components in the two cloud slabs (their spectral ID, temperature, CL, range, FOV coverage). Other outputs that are not stored in the CADSE database may include all user inputs to the simulation which need to be stored in a file with unique name.

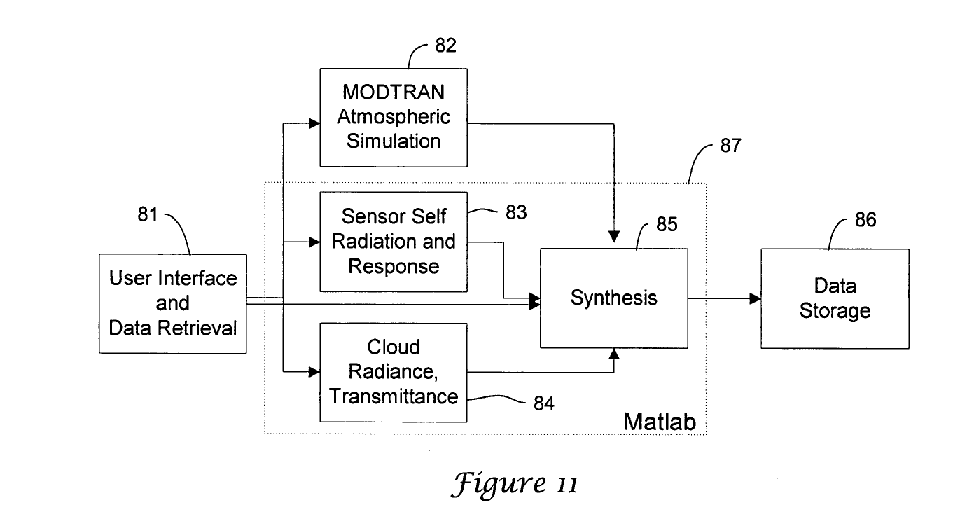

A high level operational flow diagram of the simulation software is shown in FIG. 11. A user interface and data retrieval block 81 may have an output connected to an input of a MODTRAN atmospheric simulation block 82, a sensor self radiation and response block 83 and a cloud radiance and transmittance block 84, respectively. Another output of user interface and data retrieval block 81 may go to an input of a synthesis block 85. An output of MODTRAN atmospheric simulation block 82 may go to an input of synthesis block 85. An output of sensor self radiation and response block 83 may go to an input of synthesis block 85. An output of cloud radiance and transmittance block 84 may go to an input of synthesis block 85. An output of synthesis block 85 may go to an input of a data storage block 86. Sensor self radiation and response block 83, cloud radiance and transmittance block 84 and synthesis block 85 may be contained in a Matlab module 87.

User interface and data retrieval block 81 may provide a user an interface such that the user can input the parameter values. The user interface may be in a form of a sequence of windows. Based on the input values, this block 81 may then retrieve and compute all of the required data for the simulation, e.g., the ambient blackbody, and liquid nitrogen references. Four categories of outputs defined for this block 81 may include an input file to MODTRAN block 82, inputs to sensor response/self radiation computation block 83, inputs to cloud radiance and transmission computation block 83, and inputs to synthesis block 85.

MODTRAN simulation block 82 may compute the foreground atmospheric radiance and transmission. Input to block 82 may be in a form of an input file. Outputs of block 82 may also in the form of files. Decimation of the MODTRAN outputs to match the simulated resolution may be required.

Sensor response and self radiation block 83 may compute the sensor self radiation and the sensor response, which may be used for calibration and uncalibration. Calibration may remove the sensor characteristics and artifacts before the agent/interferent spectral characteristics are added. Uncalibration, then, may add back the sensor characteristics and artifacts to the simulated spectrum. Computing the sensor self-radiation and the sensor response may require ambient black body reference interferograms, liquid nitrogen (LN₂) reference interferograms, and ambient temperature. The interferogram to spectrum transformation may be a commonly used function that involves some computations. The outputs of this transformation may be the phase corrected spectrum and the phase array. Likewise, the inverse transformation of a spectrum to an interferogram may be another commonly used function. The output of this transformation may be the interferogram.

Cloud radiance and transmission block 84 may compute the transmission and radiance of the two cloud slabs based on their temperatures, their components' absorption coefficients, and CLs. The computations for each of the cloud slabs may include computing the exponent of the transmission based on the components and their absorption coefficients (ARG as described in the simulation model), computing the transmission from the exponent, computing the radiance from the transmission and theoretical black body at the cloud temperature, and resampling the transmissivity and radiance to the synthesized signature's sample comb. The spectral range of interest may be from 700 cm⁻¹ to 1450 cm⁻¹. However, the simulation may need to extend this range further to cover any filter window, and ensure that discontinuity, which causes undesirable disturbance in the final signal, is avoided.

Synthesis block 85 may synthesize the agent/interferent into the input interferogram. Computations may include coadding (average) the number of interferograms based on the numCoadd input value, subtracting averaged liquid nitrogen interferogram from the averaged interferogram, transforming the difference interferogram to a background spectrum (I_{B-L}), computing the calibrated spectrum, or the scene radiance (N_{B}), synthesizing the simulated spectrum (N_{SIMUL}), computing the sensed simulated spectrum (I_{SIMUL}), adding appropriate noise to the simulated spectrum (I′_{SIMUL}), computing the inverse transformation to obtain the synthesized interferogram, and adding averaged liquid nitrogen interferogram in order to negate the effects of normalization for the simulated interferogram.

Data Storage block 86 may store the results into the CADSE database and to the output file. Modifications of appropriate attributes and creation of new attributes in the database may be necessary. Interface between the Matlab and the CADSE simulation module may be specified in the following. CADSE may invoke the Matlab function and pass the corresponding arguments. The Matlab function may be called Main_Simulation as described below:

| | |
|---|---|
| function [jslscad_interferogram] = | Main_Simulation( subfiles, sf_specs, sf_A, sf_L, |
| | sf_calib_file_specs, configuration_specs, |
| | absorptivity_coefficients, N_F, tau_F, step_size, ilsf, |
| | half_width) |
| where | |
| Inputs may include: | |
| subfiles | (NPTS × nscan) matrix for storage of background interferogram |
| sf_specs | nScan × 3 matrix for storage of sensor gains (col 1), centerburst |
| | (col 2),calibration file offset(col 3) |
| sf_A | NPTS × nCalibration matrix for storage of ambient blackbody |
| | calibration interferograms |
| sf_L | NPTS × nCalibration matrix for storage of liquid nitrogen |
| | calibration interferograms |
| sf_calib_file_specs | nCalibration × 5 matrix for storage of sensor gains for ambient |
| | blackbody calibration interferograms, centerburst locations for |
| | ambient BB calibration interferograms, sensor gains for liquid |
| | nitrogen calibration interferograms and centerburst locations for |
| | liquid nitrogen calibration interferograms respectively |
| configuration_specs | nscan × 23 matrix for storage of the configuration specifications |
| | per definition shown in TABLE specs below. |
| absorptivity_coefficients | nr1 × nAgent matrix for storage of agent absorptivity |
| | coefficients |
| N_F | nr1 × nScan matrix for storage of atmospheric spectral radiance |
| tau_F | nr1 × nScan matrix for storage of atmospheric spectral |
| | transmissivities |
| step_size | interferogram stepsize [micrometers] |
| ilsf | instrument line shape function |
| half_width | half width of time domain weighting function for calculation of |
| | reference spectrum. |
| Outputs may include: | |
| jslscad_interferogram | NPTS × nScan array for storage of synthetic interferogram |

The number of points per interferogram, NPTS, may be defined internally.

TABLE
specs may include:

| Matrix | |
|---|---|
| Column | Definition |
| 1 | Ambient Temperature |
| 2 | Spectral Resolution |
| 3 | FOV coverage |
| 4 | Cloud Slab #1 - temperature |
| 5 | Cloud Slab #1 - number of components |
| 6 | Cloud Slab #1 - component 1 absorptivity coefficients offset |
| 7 | Cloud Slab #1 - component 2 absorptivity coefficients offset |
| 8 | Cloud Slab #1 - component 3 absorptivity coefficients offset |
| 9 | Cloud Slab #1 - component 4 absorptivity coefficients offset |
| 10 | Cloud Slab #1 - component 1 CL |
| 11 | Cloud Slab #1 - component 2 CL |
| 12 | Cloud Slab #1 - component 3 CL |
| 13 | Cloud Slab #1 - component 4 CL |
| 14 | Cloud Slab #2 - temperature |
| 15 | Cloud Slab #2 - number of components |
| 16 | Cloud Slab #2 - component 1 absorptivity coefficients offset |
| 17 | Cloud Slab #2 - component 2 absorptivity coefficients offset |
| 18 | Cloud Slab #2 - component 3 absorptivity coefficients offset |
| 19 | Cloud Slab #2 - component 4 absorptivity coefficients offset |
| 20 | Cloud Slab #2 - component 1 CL |
| 21 | Cloud Slab #2 - component 2 CL |
| 22 | Cloud Slab #2 - component 3 CL |
| 23 | Cloud Slab #2 - component 4 CL |

A two-slab cloud model may be used in the agent/interferent simulation software. FIG. 2 shows the geometry of the two-slab cloud model for the agent/simulant/interferent simulation. The simulation may model the sensed radiance as the cumulative effects of the background radiance, the radiance and transmission of clouds 91 and 92 (C1 and C2) and that of the foreground. Thus, the four components (i.e., background, Cloud 91 (C1), cloud 92 (C2), and foreground) of the model may have their own radiance, N_{B′}, N_{C1}, NC_{C2}, and N_{F}, respectively. The two cloud slabs and the foreground may have their own transmission, τ_{C1}, τ_{C2}, and τ_{F}, respectively. The two cloud slabs may be assumed to be at the same distance from sensor 21. Each cloud (91, 92) may be composed of a homogeneous mixture of chemical components at a specific temperature. The simulation may allow a maximum of four components in each cloud slab. Each component may be represented by a set of absorption coefficients at a specific concentration x path length (CL). In addition, the back cloud, C2, may be assumed to have a 100 percent field of view (FOV) coverage but the front cloud, C1, may have a 0 to 100 percent FOV coverage. A shadow factor, s₁, which has a value of 0 to 1, may be defined as the fraction of cloud 91 (C1) covering cloud 92 (C2) within the FOV coverage. Thus, s₁=1 may imply that both clouds 91 and 92 are within the FOV, and s₁=0 may imply that cloud 91 (C1) is outside of the FOV. For convenience, another term, s₂, may be defined as 1−s₁.

The model may implicitly simulate one cloud slab. Several methods may be used to accomplish this. Setting s₁=0 is one way; setting the number of components in one of the clouds to be zero is another way. This model may assume that sensor 21 measured the sensed signal (interferogram) without the two clouds, I_{B}. The sensed interferogram, I_{B}, may be converted to radiance without the cloud, N_{B}. One may assume that N_{B}=τ_{F}N_{B}+N_{F}. Then the simulated radiance, N_{SIMUL}, entering the sensor may be

N_{SIMUL}=s₁(N_{B}−N_{F})τ_{C1}τ_{C2}+s₂(N_{B}−N_{F})τ_{C2}+N_{F}+s₁N_{C2}τ_{C1}τ_{F}+s₂N_{C2}τ_{F}+s₁N_{C1}τ_{F} . . . .

This simulated radiance may passes through sensor 21, which may detect the radiance and output the simulated sensed radiance, I_{SIMUL} as

I′_{SIMUL}=N_{SIMUL}*R

This equation does not take into account the artificial attenuation of the noise originally in the measured background spectrum. (The noise compensation may take place in the raw spectrum after the simulated radiance spectrum has been uncorrected for sensor spectral response.) One may note that

I_{SIMUL}=I′_{SIMUL}+Nₙₒᵢₛₑ.

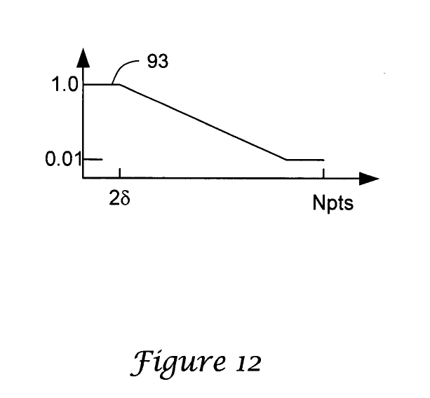

For now, the noise spectrum, Nₙₒᵢₛₑ, may be assumed to be 0, because the noise is not estimated accurately. A more definitive method to capture or compute the noise may be needed. I_{SIMUL} may be in the spectral domain. Following computations of a method 1 may transform I_{SIMUL} to an interferogram: 1) Restore phase from the reference phase (computed in the forward transformation); 2) Normalize the phase compensated measurement data plus agent spectrum by the phase compensated measurement data spectrum, I_{B}; 3) Perform inverse FFT; 4) Truncate the transformed interferogram to half its length (assume zero-filled before); 5) Remove original apodization effect by dividing the truncated interferogram with a window shown in FIG. 12 (δ is the maximum peak location 93 in the figure); 6) Combine the gain compensated measurement data interferogram with the unapodized difference scaled by a factor of 2.0; and 7) Un-normalize with original gain.

Following may provide all the equations for computing the terms in the above equations. s₁ is the shadow factor, which may be the fraction of cloud C1 covering cloud C2 within the FOV. Thus, s₂ may equal 1−s₁.

R may be a response of the sensor and is computed as:

$$R = \frac{{I}_{A - L}}{{N}_{BB}^{A} - {N}_{BB}^{L}}$$

where

N_{BB}^{A}=the theoretical black body at ambient temperature, and

N_{BB}^{L}=the theoretical black body at the temperature of liquid nitrogen (77° K.).

The theoretical black body may be computed using Planck's function with

N_{BB}^{T}=c₁×\overline{ν}³/(e^{c2\overline{ν}/T}−1) w/cm²/cm⁻¹/st,

where

c₁=1.19089×10⁻¹² w cm² sr⁻¹,

c₂=1.4388 cm·° K.,

\overline{ν}=wavenumber value (cm⁻¹),

T=temperature (° K.), and

N_{B}=total radiance of the background and foreground, (without the cloud slabs).

N_{B} may be computed from calibrating the spectrum, I_{B-L}, which is the measured background signal with the sensor self radiation removed, as

$${N}_{B} = \frac{{I}_{B - L}}{R}$$

I_{B-L} and I_{A-L} may be computed from the background (B) and the averaged ambient blackbody (A) interferograms (referred to as the input interferogram below) respectively. They may be computed with a method 2 as follows: 1) Normalize the input interferogram for gain; 2) Subtract the normalized averaged liquid nitrogen interferogram from the normalized input interferogram; 3) Apodize the difference interferogram using a triangular apodization function, which has a value of 0.5 at the center burst location (location of zero phase reference) and 0 values at the extended points 0 and Npts+1; 4) Zero-fill the apodized interferogram to double the length; 5) Apply FFT to the zero-filled interferogram; and 6) Phase correct the resulting spectrum with the generalized version of the Mertz method that accounts for both magnitude and phase.

One may note the following term definitions.

N_{F}, τ_{F}=the radiance and transmission of the foreground;

N_{C1}, τ_{C1}=the radiance and transmission of the front cloud slab, C1; and

N_{C2}, τ_{C2}=the radiance and transmission of the back cloud slab, C2.

The terms may be computed as

τ_{c1}=e^{-ARG}^{_{C1}} and τ_{C2}=e^{-ARG}^{_{C3}},

N_{C1}=N_{BB}^{C1}(1−τ_{C1}) and N_{C2}=N_{BB}^{C2}(1−τ_{C2}),

where

ARG_{C1}=α₁CL₁+α₂CL₂+ . . . +αₙCLₙ,

ARG_{C2}=α₁CL₁+α₂CL₂+ . . . +αₘCLₘ,

αᵢ=absorption coefficient for component i as a function of \overline{ν}, and

N_{BB}^{Ci}=The theoretical blackbody at the temperature of cloud i, for i=1,2.

The following function, f(x), may be used in the decimation process—that is to convolve it with a high resolution sampled sequence, followed by an interpolation and subsample. The resulting sequence may have a lower resolution.

The convolution function may be

$$f ( x ) = sin {c}^{2} x = \frac{{sin}^{2} x}{{x}^{2}}$$

(for triangular apodization), and

x=0.88 π\overline{ν}/fwhm,

where

\overline{ν}=displacement from center of function (cm⁻¹), and

fwhm=full width at half maximum.

For JSLSCAD-like data, one may use a 33 point function, normalized to unit area. If the high resolution sample interval is 1.84451968, and the laser diode frequency is 0.662, then

\overline{ν}=1.84451968×INDEX (from center of function) cm⁻¹, and fwhm=3.2.

It may be noted that the above discussion is in the spectral domain. The input to the simulation may be an interferogram. Thus, the simulation may first transform the input from the time domain to the spectral domain. Then the agent and interferent synthesis as outlined may be performed. Afterwards, the inverse transformation may convert the synthesized spectrum back to the simulated interferogram.

Although the invention has been described with respect to at least one illustrative embodiment, many variations and modifications will become apparent to those skilled in the art upon reading the present specification. It is therefore the intention that the appended claims be interpreted as broadly as possible in view of the prior art to include all such variations and modifications.

What is claimed is:

1. A signature simulator comprising:
a ground truth tool comprising:
a first input of atmosphere conditions; and
a second input of field data; and
an output of selected data; and
a simulation module comprising:
a first input of an agent absorption coefficient;
a second input of system performance requirements; and
an output.

2. The simulator of claim 1, further comprising:
a training data module comprising:
an input connected to the output of the simulation module; and
an output.
a sequestered test data module comprising:
an input connected to the output of the simulation module and;
an output.

3. The simulator of claim 2, further comprising an algorithm development module comprising:
a first input connected the output of the training data module;
a second input; and
an output.

4. The simulator of claim 3, further comprising a detection performance test and evaluation module comprising:
a first input connected to the output of the sequestered test data module;
a second input connected to the output of the algorithm development module; and
an output connected to the second input of the algorithm development module.

5. A simulation system comprising:
an atmospheric radiance and transmission modeling module;
an atmospheric conditions source connected to the atmospheric radiance and transmission modeling module;
a sensor response removal module;
a field data source connected to the sensor response removal module;
a sensor response source connected to the sensor response removal module;
a special characteristics addition module connected to the sensor response removal module;
an atmospheric attenuation module connected to the atmospheric radiance and transmission modeling module and to the special characteristics addition module; and
a sensor response addition module connected to the sensor response source and to the atmospheric attenuation module.

6. The system of claim 5, wherein the sensor response addition has a simulated data output.

7. A simulator system comprising:
a chemical agent detection environment simulation device;
a user interface connected to the chemical agent detection environment simulation device;
a background measurement environment interferogram source connected to the chemical agent detection environment simulation device;
a numerical computing tool connected to the chemical agent detection environment simulation device; and
an atmospheric transmittance and radiance model connected to the chemical agent detection environmental simulation device.

8. The system of claim 7, further comprising an ancillary information source connected to the chemical agent detection environment simulation device.

9. The system of claim 8, wherein:
files may be input to the atmospheric transmittance and radiance model from the chemical agent detection simulation device environment; and
atmospheric model information may be input to the chemical agent detection environment simulation device from the atmospheric transmittance and radiance model.

10. A simulation method comprising:
computing parameters of a plurality of parameters of spectrums;
calibrating a background spectrum;
constructing an atmospheric model;
construction a cloud model; and
building simulated spectra from the plurality of parameters of spectrums, the background spectrum, the atmospheric model and the cloud model.

11. The method of claim 10 further comprising signal-to-noise compensation of the simulated spectrum.

12. A means for simulating comprising:
means for computing parameters for at least one spectrum;
means for calibrating a background spectrum;
means for constructing an atmospheric model;
means for constructing a cloud model;
means for simulating a signature from the at least one spectrum, the background spectrum, the atmospheric model and the cloud model.

13. The means of claim 12, further comprising a means for improving a signal-to-noise factor of the signature.

14. A system for simulation comprising:
a user interface;
an atmospheric simulation module connected to the user interface;
a sensor radiation and response module connected to the user interface;
a cloud radiance and transmittance module; and
a synthesizer connected to the atmospheric simulation module, the sensor radiation and response module, and the cloud radiance and transmittance module.

15. The system of claim 14, further comprising a data storage module connected to the synthesizer.

16. The system of claim 15, wherein the sensor radiation and response module, the cloud radiance and transmittance module and the synthesizer are operated with a numerical computing tool.

17. The system of claim 16, wherein the numerical computing tool is a Matlab® module.

18. The system of claim 16, wherein the atmospheric simulation module is a MODTRAN module.

19. A signature simulator comprising:
an input stage;
a preparation stage;
a calibration stage; and
a simulation stage; and
wherein the simulation stage comprises:
a background spectrum;
an atmospheric model;
a cloud model; and
a simulated spectrum builder.

20. The simulator of claim 19 wherein calibration stage comprises:
computing an ambient blackbody spectrum;
computing a theoretical ambient blackbody spectrum; and
computing a calibrated background spectrum.

21. The simulator of claim 20, wherein the calibration stage further comprises computing an LN₂ reference spectrum.

22. The simulator of claim 21, wherein the simulated spectrum builder may output a simulated signature.
